(19) United States
(12) Patent Application Publication
(10) Pub. No.: US 2012/0290984 A1
(43) Pub. Date: Nov. 15, 2012

(54) Computer-Implemented Systems And Methods For Data Item Interface Processing

(76) Inventors: Qing Gong, Cary, NC (US); Huifang Wang, Cary, NC (US)

(21) Appl. No.: 13/104,415

(22) Filed: May 10, 2011

(51) Int. Cl. G06F 3/048

(52) U.S. Cl. 715/841

(57) ABSTRACT

Computer-implemented systems and methods are disclosed for displaying a number of data items within a graphical user interface. Data items retrieved from a data store (e.g., a database) may be assigned, based on a first predetermined criterion, to first level bins. A first level bin identifier is associated with each first level bin. One or more first level bin identifiers are displayed in a list within a graphical user interface. Upon user operation on a displayed first level bin identifier associated with a particular first level bin, data items contained in the particular first level bin are displayed in the list.

### TECHNICAL FIELD

The present disclosure relates generally to the field of user interface processing and, more specifically, to computer-implemented systems and methods for data item interface processing.

### BACKGROUND

User interfaces have evolved to handle many different types of data for display to a user. Typical user interface components that are displayed to a user can include a drop-down list, a list control, etc. Such components allow users to select from a list of items. However, these user interface components and others have problems in displaying data items in an efficient and effective manner.

### SUMMARY

As disclosed herein, computer-implemented systems and methods are provided for displaying a number of data items within a user interface, such as a graphical user interface. For example, data items retrieved from a database may be assigned, based on a first predetermined criterion, to a set of bins at a particular level (e.g., first level bins; note that the term “first level” does not necessarily indicate a top-most level or bottom-most level, but indicates more generally a level which could be a top, bottom, or middle level). A first level bin identifier is associated with each first level bin. One or more first level bin identifiers are displayed in a list within a user interface. Upon user operation(s) with respect to a displayed first level bin identifier, data items associated with the first level bin identifier are displayed in the list.

As another example, a hierarchy of bins is established based on a second predetermined criterion. The first level bins occupy the lowest level of the hierarchy. Each bin, other than the first level bins, contains one or more bins of a next lower level in the hierarchy. A bin identifier is associated with each bin in the hierarchy. One or more bin identifiers of a particular level of the hierarchy are displayed in the list within a user interface, such as a graphical user interface. Upon user operation(s) on a displayed bin identifier associated with a particular bin, data items contained in the particular bin, bin identifiers associated with bins contained in the particular bin, or data items and bin identifiers associated with bins contained in the particular bin are displayed in the list.

As another example, a list of data items can be displayed by grouping the data items into bins or a hierarchy of bins and displaying bin identifiers instead of all data items. A list of bin identifiers displayed in a GUI can be expandable to display bin identifiers of a next lower level and/or data items contained in bins. Also, the list of bin identifiers may be collapsible to display a bin identifier of a next higher level. Visual indications may be used to show users whether a list displayed in a GUI can be expanded or collapsed.

### BRIEF DESCRIPTION OF THE DRAWINGS

FIG. 1 depicts a computer-implemented environment wherein users can interact with a data item interface processing system hosted on one or more servers through a network.

FIG. 2 depicts an example of a system block diagram for displaying a number of data items in a GUI.

FIG. 3 depicts another example of a block diagram for displaying a number of data items in a GUI.

FIG. 4 depicts an example of a flow chart for displaying a number of data items in a GUI.

FIG. 5 depicts another example of a flow chart for displaying a number of data items in a GUI.

FIGS. 6A-6D depict an example embodiment where a displayed list contains ordered bins and upon user operation the list expands to access a data item a user desires.

FIGS. 7A-7C depict an example embodiment where data items are assigned to bins based on last names and upon user operation the list expands to get to a data item a user desires.

FIGS. 8A-8C depict an example embodiment where data items are assigned to bins based on states and upon user operation the list expands to get to a data item a user desires.

FIG. 9 depicts an example embodiment where visual indications are displayed to indicate options of expanding or collapsing a list.

FIG. 10 depicts a data item interface processing system provided on a stand-alone computer for access by a user.

### DETAILED DESCRIPTION

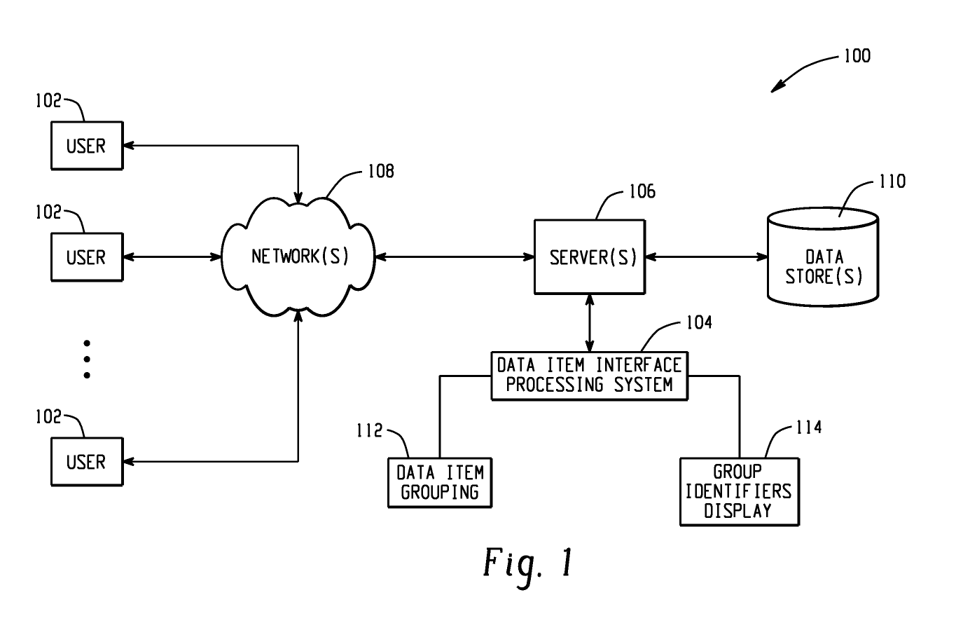

FIG. 1 depicts a computer-implemented environment wherein users 102 can interact with a data item interface processing system 104 hosted on one or more servers 106 through a network 108. The data item interface processing system 104 can help in displaying data items in a user interface, such as a graphical user interface (GUI). For example, in a telephone address lookup application, a user 102 may wish to locate a particular person's address from among many addresses contained in their address database. Instead of displaying all of the addresses data items in the user's GUI, the data item interface processing system 104 can perform operations, such as data item grouping operation 112 and group identifier display operation 114, to render a display of the data items in an efficient and effective manner.

As an illustration, the grouping operation 112 can automatically group certain address data items together into bins based upon the data items having one or more common or similar characteristics to each other. A user can then locate and access a particular address data item through bin identifiers which are displayed through the group identifier display operation 114. The group identifier display operation 114 can yield many different types of displays, such as by providing an interface which allows the user 102 to scroll through the displayed bin identifiers to get to the region of the list where the desired address data item is located. The list of bin identifiers may then expand upon user operation until the desired data item is shown in the GUI for selection. In this way, a list of data items can be displayed more efficiently by grouping the data items into bins (or a hierarchy of bins) and displaying bin identifiers instead of all data items.

As shown in FIG. 1, the users 102 can interact with the system 104 through a number of ways, such as over one or more networks 108. One or more servers 106 accessible through the network(s) 108 can host the data item interface processing system 104. The one or more servers 106 can also contain or have access to one or more data stores 110 for storing data for the system 104, such as any databases or data files containing the data items for display on a GUI.

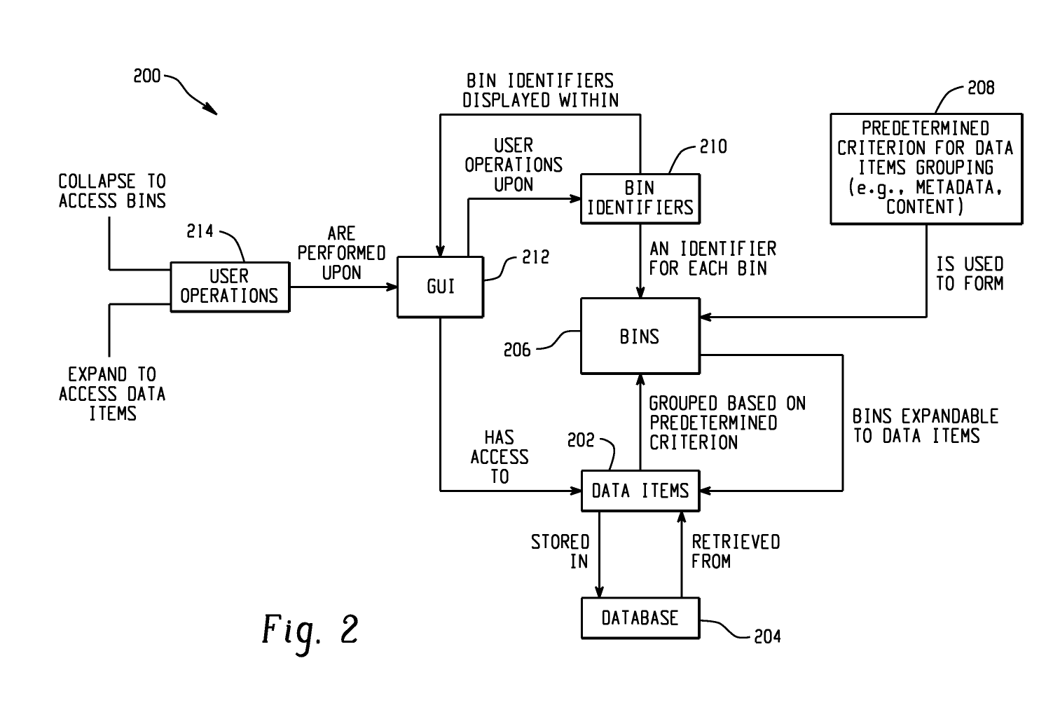

FIG. 2 depicts at 200 example software components for processing data items for display in a GUI. In the processing example of FIG. 2, the data items 202 can be grouped into bins 206 based on one or more predetermined criteria 208. Instead of displaying all data items 202 on a GUI 212, a list of bin identifiers 210 that represent any number of data items can be displayed on the GUI 212. A user can perform an operation 214 (e.g., a mouse click, etc.) upon the bin identifiers 210 to get to data items or a lower level of bin identifiers.

The data items themselves 202 may be retrieved from a data store (e.g., database 204) and then can be assigned to the bins 206 based on the predetermined criterion 208. Many different criteria can be chosen for assigning the data items, such as content of data items and/or metadata associated with the data items. The bins 206, when expanded, display their respectively associated data items. To facilitate operations with respect to the bins 206, bin identifiers 210 are associated with the bins 206.

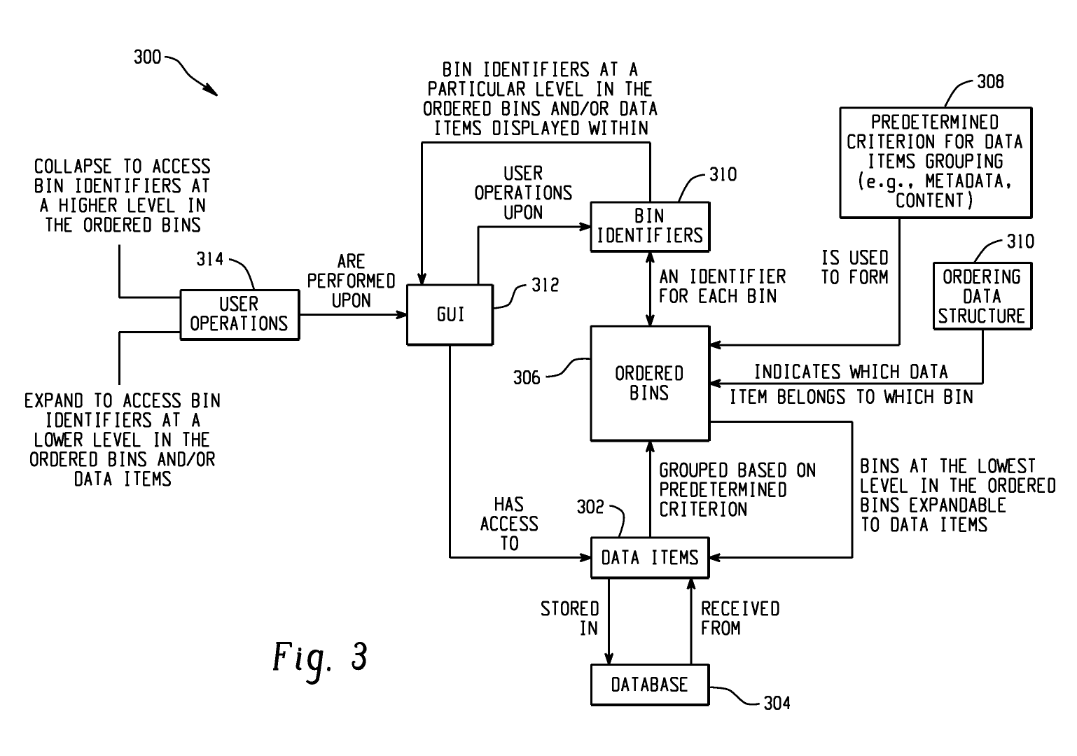

FIG. 3 depicts at 300 another example configuration of software components for displaying data items in a GUI. In this example, data items 302 can be grouped into a hierarchy of ordered bins 306 based on one or more predetermined criteria 308. The software components are configured to display a list of bin identifiers associated with a particular level in the hierarchy and/or data items on GUI 312. A particular bin may contain data items only, bins at a next lower level only, or both data items and bins at a next lower level. Upon user operation(s) 314 on a displayed bin identifier, the list of bin identifiers collapse to access bin identifiers at a higher level in the hierarchy, or expand to a lower level of bin identifiers and/or data items.

Similar to the processing described above, data items 302 in FIG. 3 can be retrieved from a datastore, such as a database 304. The data items 302 may then be assigned to ordered bins 306 based on the predetermined criteria 308. The ordered bins 306 can form a hierarchy that includes an ordering data structure 310 indicating which data items belong to which bins. For example, the data items may be assigned to first level bins based on a first predetermined criterion. A hierarchy of bins can be established based on a second predetermined criterion, where the first level bins occupy the lowest level of the hierarchy. The first and second criteria may be the same, such as both criteria being based on content of data items and metadata of the data items.

A bin at the lowest level of the hierarchy can be expanded to data items contained in the bin. Each bin, other than the bins at the lowest level, contains one or more bins at a next lower level in the hierarchy, or bins at a next lower level and data items. A particular bin at a level other than the lowest may expand to bins at a next lower level and/or data items contained in the particular bin. Correspondingly, a particular bin at a level other than the highest may collapse to a next higher level bin that contains the particular bin.

A bin identifier 310 is associated with each of the ordered bins 306. Bin identifiers associated with bins at a particular level in the hierarchy and/or data items may be displayed in a list within a GUI 312. Upon user operation(s) 314 on a displayed bin identifier associated with a particular bin, the displayed list expands to display data items contained in the particular bin, bin identifiers associated with bins contained in the particular bin, or data items and bin identifiers associated with bins contained in the particular bin.

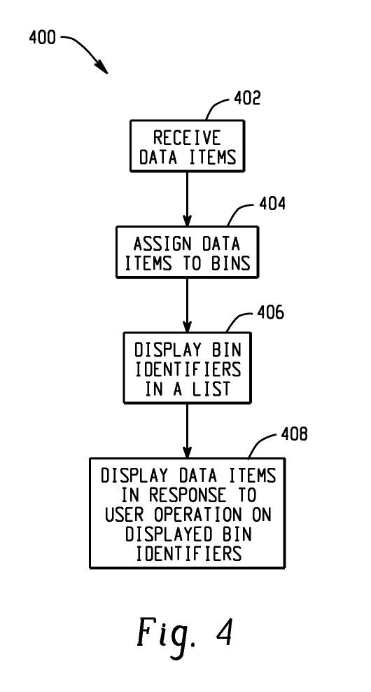

From an overall processing perspective, the system operations can be configured such as shown in FIG. 4. FIG. 4 depicts at 400 an example set of operations for displaying data items in a GUI where data items that are retrieved at 402 are assigned to bins based on a predetermined criterion at 404. A list of bin identifiers may be displayed in a GUI at 406. Upon user operation(s) on a displayed bin identifier associated with a particular bin, the displayed list expands to display data items contained in the particular bin at 408.

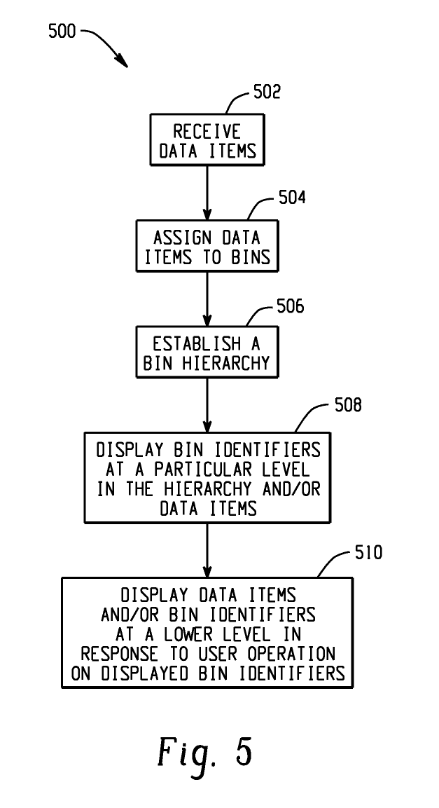

FIG. 5 depicts at 500 another example of operations configured to display data items in a GUI. In FIG. 5, data items retrieved at 502 are assigned to first level bins based on a first predetermined criterion at 504. A hierarchy of bins may be established based on a second predetermined criterion at 506, where the first level bins occupy the lowest level of the hierarchy. Bin identifiers associated with bins at a particular level in the hierarchy and/or data items may be displayed in a list within a GUI at 508. A particular bin may contain data items only, bins at a next lower level only, or both data items and bins at a next lower level. At 510, upon user operation(s) on a displayed bin identifier associated with a particular bin, the displayed list expands to display data items contained in the particular bin, bin identifiers associated with bins contained in the particular bin, or data items and bin identifiers associated with bins contained in the particular bin.

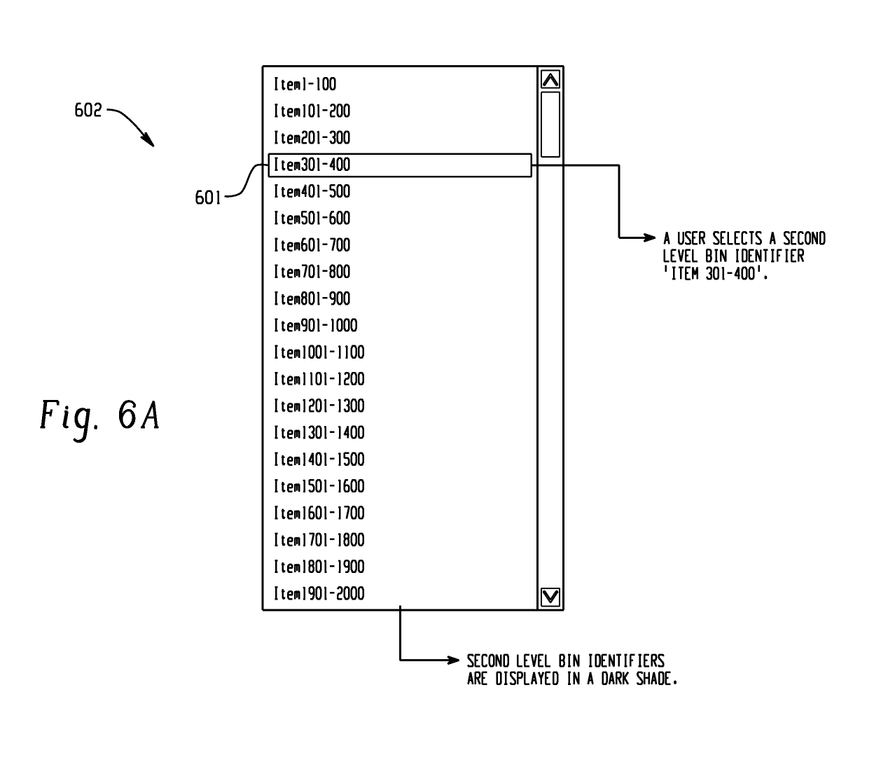

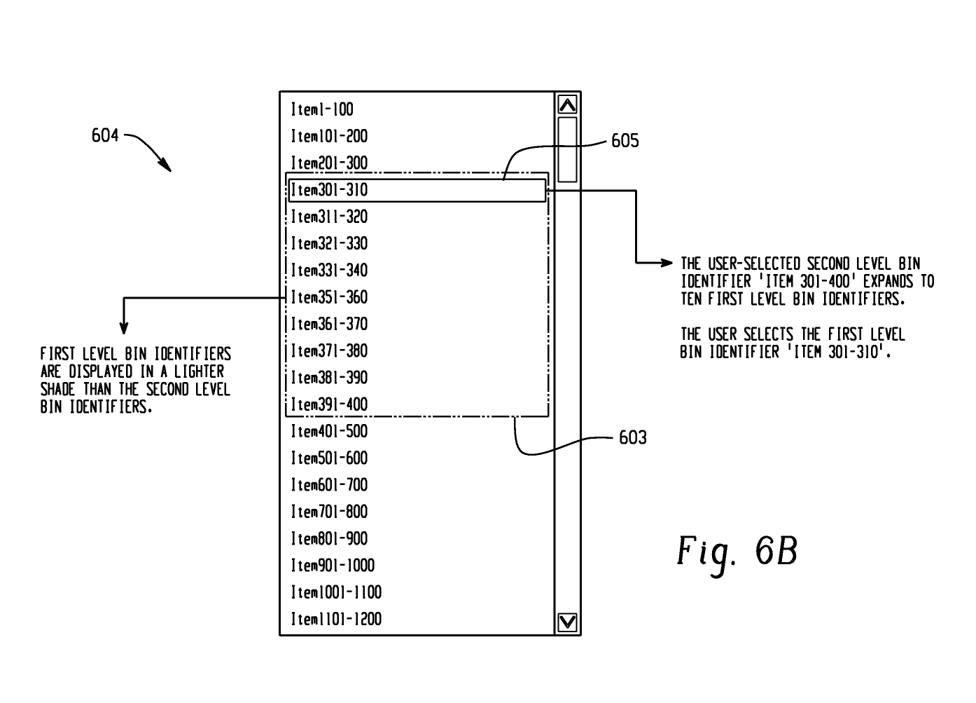

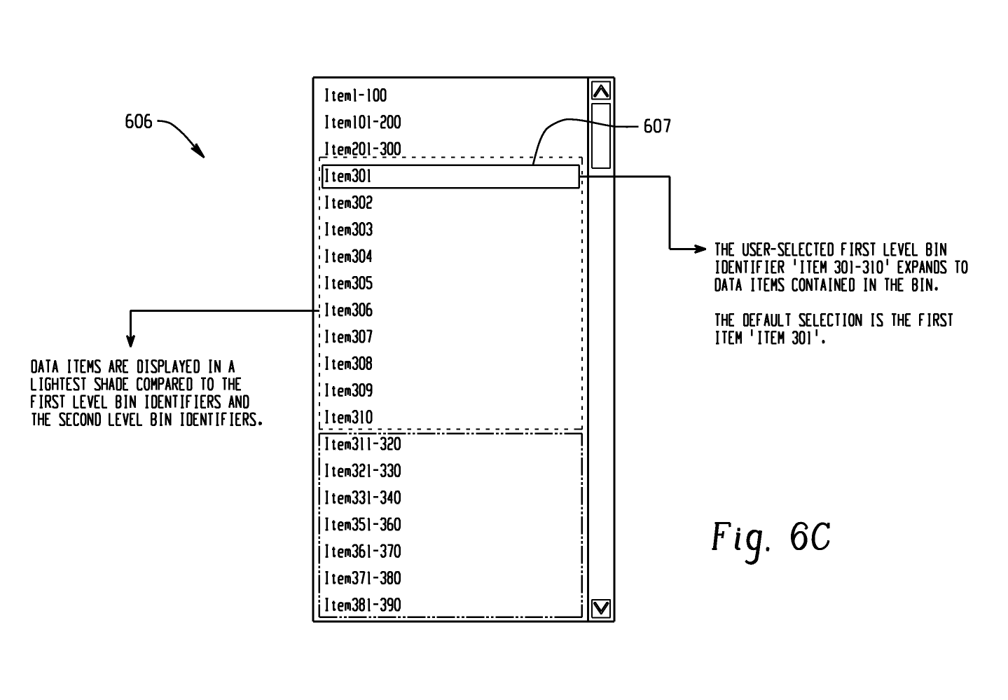

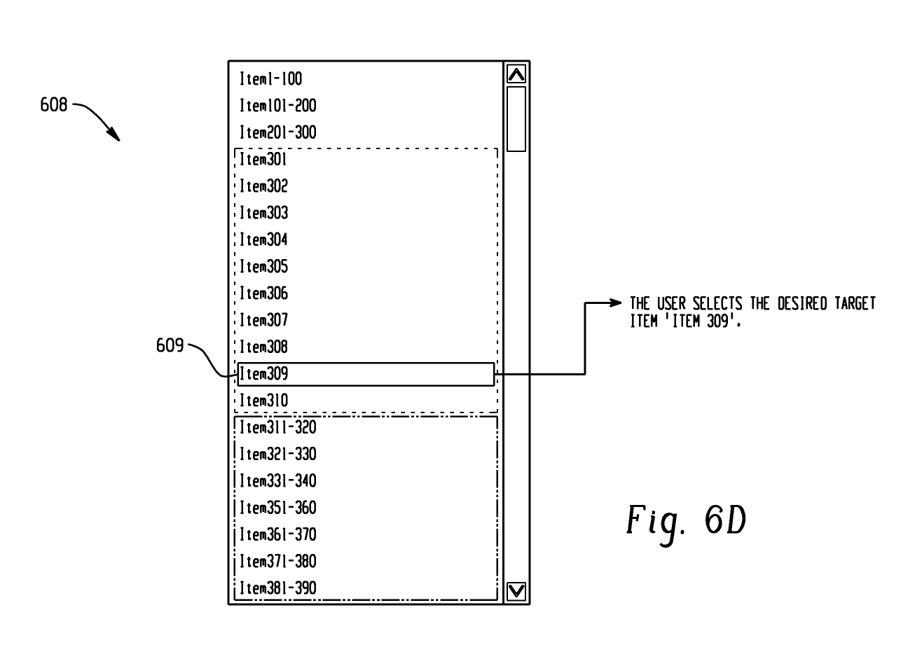

FIGS. 6A-9 provide examples of data items being grouped into bins which are identified by bin identifiers. With respect to the first example, FIGS. 6A-6D depict an embodiment where a displayed list contains ordered bins and upon user operation the list expands to get to a data item a user desires. In FIGS. 6A-6D, a user traverses through higher level bin identifiers (e.g., “Item301-400” on FIG. 6A) to locate from among thousands of potential data items a specific data item (e.g., data item “Item309” on FIG. 6D).

More specifically, FIG. 6A shows a higher-level grouping of data items, which in this example, operate as second level bin identifiers (e.g., “Item1-100”). In this example, the overall list contains ten thousand data items in total which are assigned to ordered bins. The ordered bins in this example include two levels, a first level and a second level. Each of the first level bins contains ten data items, while each of the second level bins contains ten first level bins and thus a hundred data items. A bin identifier is associated with each bin, and may include a label that indicates the range of data items contained in the bin, e.g. “Item301-400.” Bin identifiers of a particular level may be displayed in the list. For example, one hundred bin identifiers of the second level may be displayed in the list, as shown at 602 in FIG. 6A.

If a user needs item 309, for example, he may scroll to the second level bin identifier “Item301-400” first. Then as shown at 604 in FIG. 6B, upon user operation(s) (e.g., a single click, a double-click, a mouse-over, a click-and-hold, a pinch-in, a pinch-out, etc.) on the bin identifier “Item301-400” associated with a second level bin, the list may expand to display ten first level bin identifiers (from “Item301-310” to “Item391-400”) associated with the first level bins that are contained in the second level bin.

To get to the desired item 309, the user may select the first level bin identifier “Item301-310.” As shown at 606 in FIG. 6C, upon user operation(s) on the first level bin identifier “Item301-310,” the list may expand to show data items contained in the first level bin associated with the first level bin identifier “Item301-310.” The default selection may be the first data item “Item301.” The user may move down the list to select “Item309” as shown at 608 in FIG. 6D.

A color shading scheme may be used for displaying the list, where a dark shade may be used for second level bin identifiers, a lighter shade for first level bin identifiers, and a lightest shade for data items. For example, in FIG. 6A, the second level bin identifiers are displayed in a dark shade, while the bin identifier “Item301-400” is highlighted to indicate user selection. In FIG. 6B, the ten first level bin identifiers (from “Item301-310” to “Item391-400”) are displayed in a lighter shade than the second level bin identifiers in the background. Further, in FIG. 6C, the ten data items (from “Item301” to “Item310”) are displayed in a lightest shade compared to the first level bin identifiers and the second level bin identifiers.

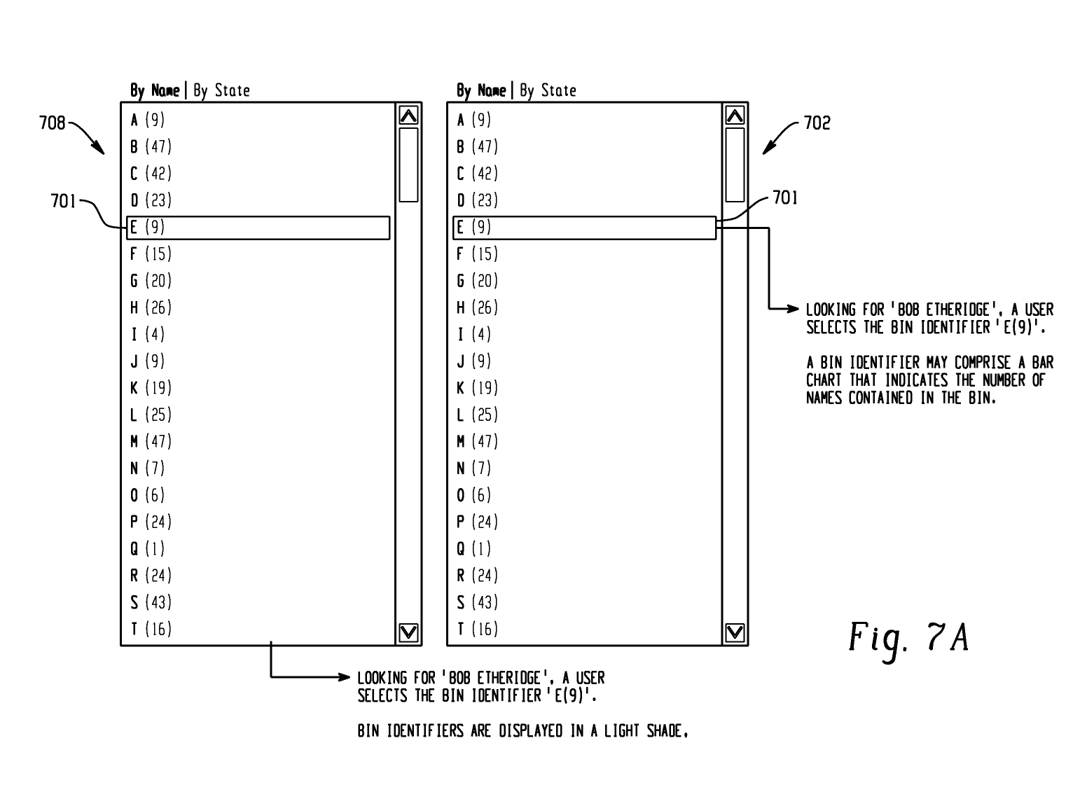

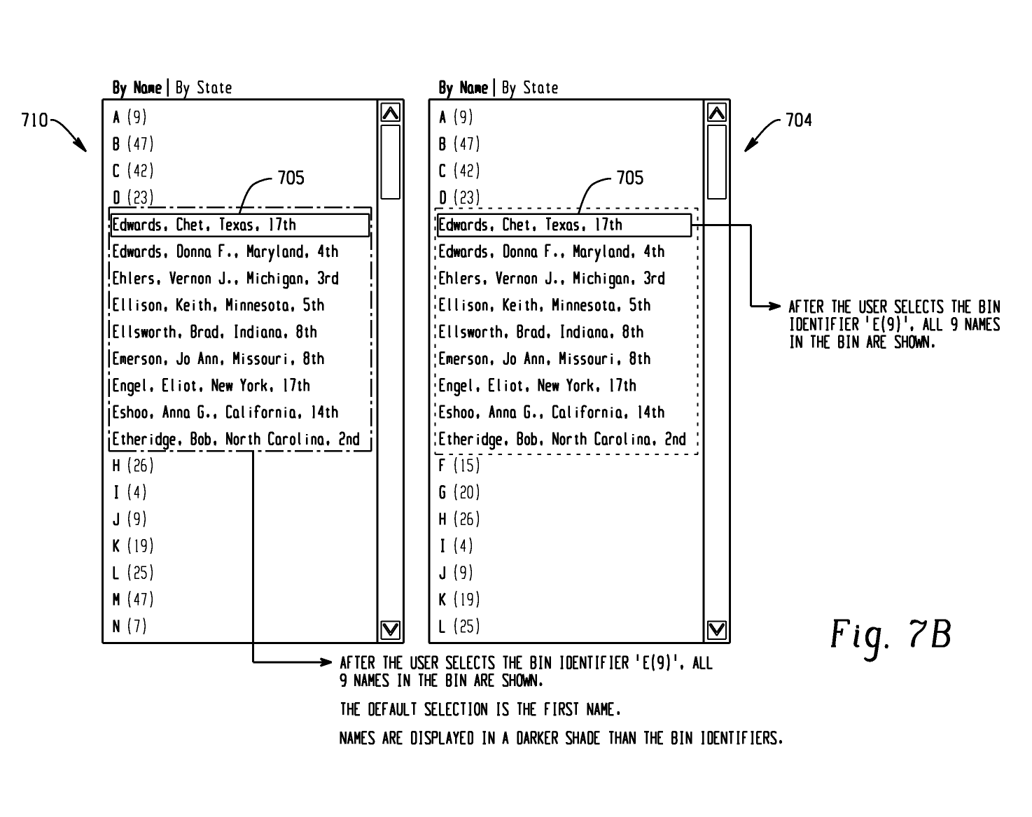

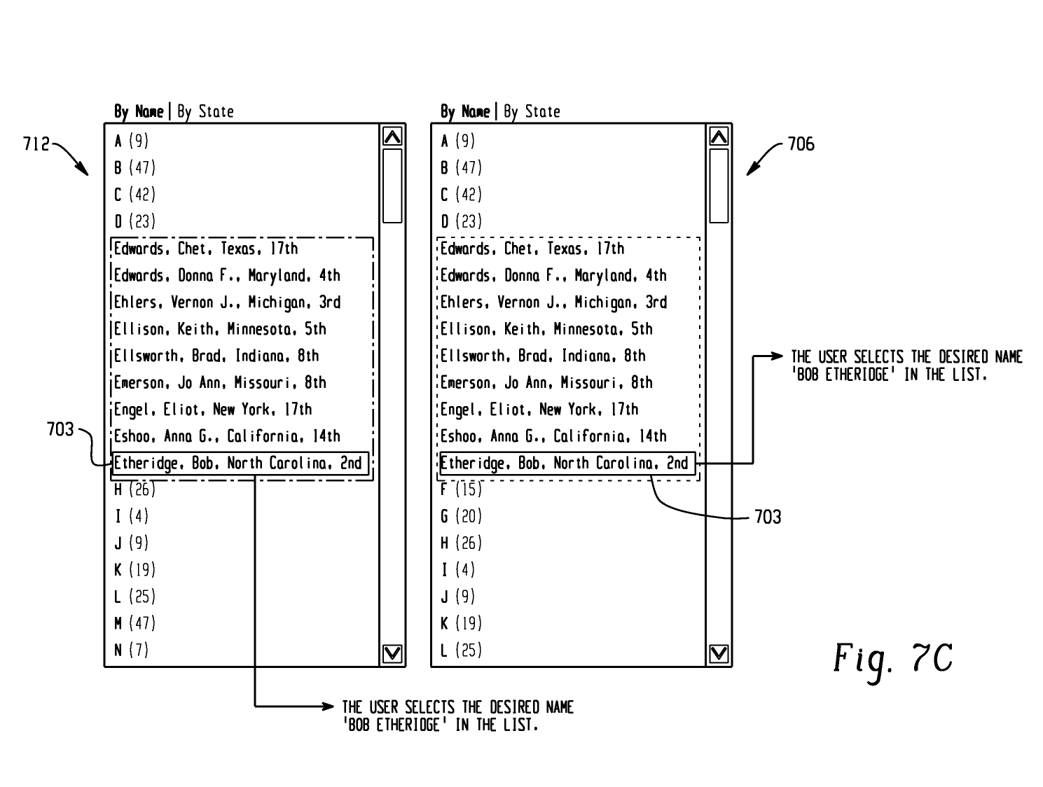

FIGS. 7A-7C depict an example embodiment where data items are assigned to bins based on last names and upon user operation the list expands to get to a data item a user desires. Generally, FIGS. 7A-7C illustrate a user traversing through displayed bin identifiers (e.g., “E” on FIG. 7A) to locate from among hundreds of names a specific name (e.g., data item “Etheridge, Bob, North Carolina, 2nd” on FIG. 7C).

More specifically, FIG. 7A shows an one-level grouping of data items based on last names. The overall list of congressmen's names are assigned into bins based on congressmen's last names. A bin identifier is associated with each bin, and may include a first letter of a congressman's last name and a number in brackets indicating how many names are in the bin. In addition, a bin identifier may comprise a bar chart to indicate the number of names contained in the bin associated with the bin identifier, as shown at 702 in FIG. 7A, 704 in FIG. 7B, and 706 in FIG. 7C. Users can learn from the lengths of the bar charts which bin contains more names. Bin identifiers are displayed in a list within a GUI.

If a user is looking for a congressman “Bob Etheridge,” for example, the user may scroll to the bin identifier “E (9),” as shown at 702 and 708 in FIG. 7A. Then upon user operation (e.g., a single click, a double-click, a mouse-over, a click-and-hold, a pinch-in or a pinch-out) on the bin identifier “E (9),” the list may expand to display nine congressmen's names contained in the bin associated with the bin identifier “E (9),” as shown at 704 and 710 in FIG. 7B, wherein “(9)” indicates that the bin contains nine items. The default selection may be the first name “Edwards, Chet, Texas, 17th.” The user may move down the list to select “Etheridge, Bob, North Carolina, 2nd,” as shown at 706 and 712 in FIG. 7C.

A color shading scheme may be used for displaying the list of congressmen's names, where a light shade is used for bin identifiers and a darker shade is used for names. For example, as shown at 708 in FIG. 7A, the bin identifiers are displayed in a light shade, while the bin identifier “E (9)” is highlighted to indicate user selection. The bracketed numbers contained in the bin identifiers may take a lighter shade to indicate they are not part of the names. As shown at 710 in FIG. 7B, the congressmen's names are displayed in a darker shade than the bin identifiers in the background.

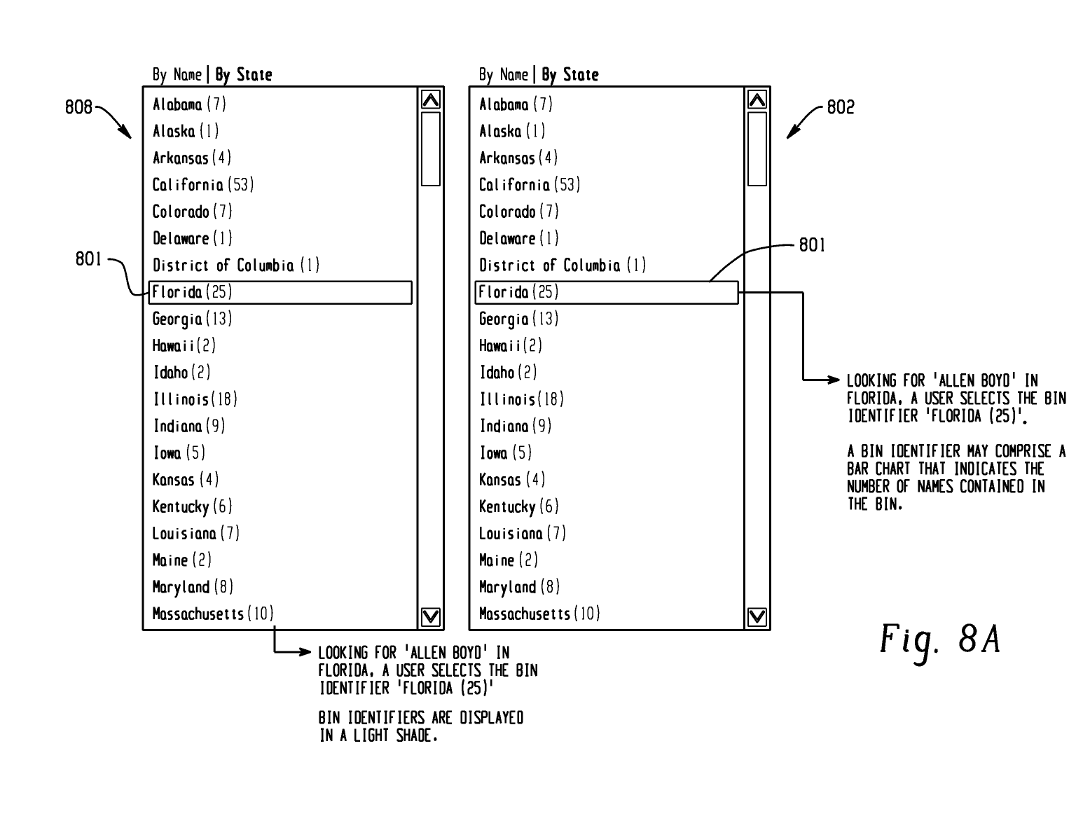

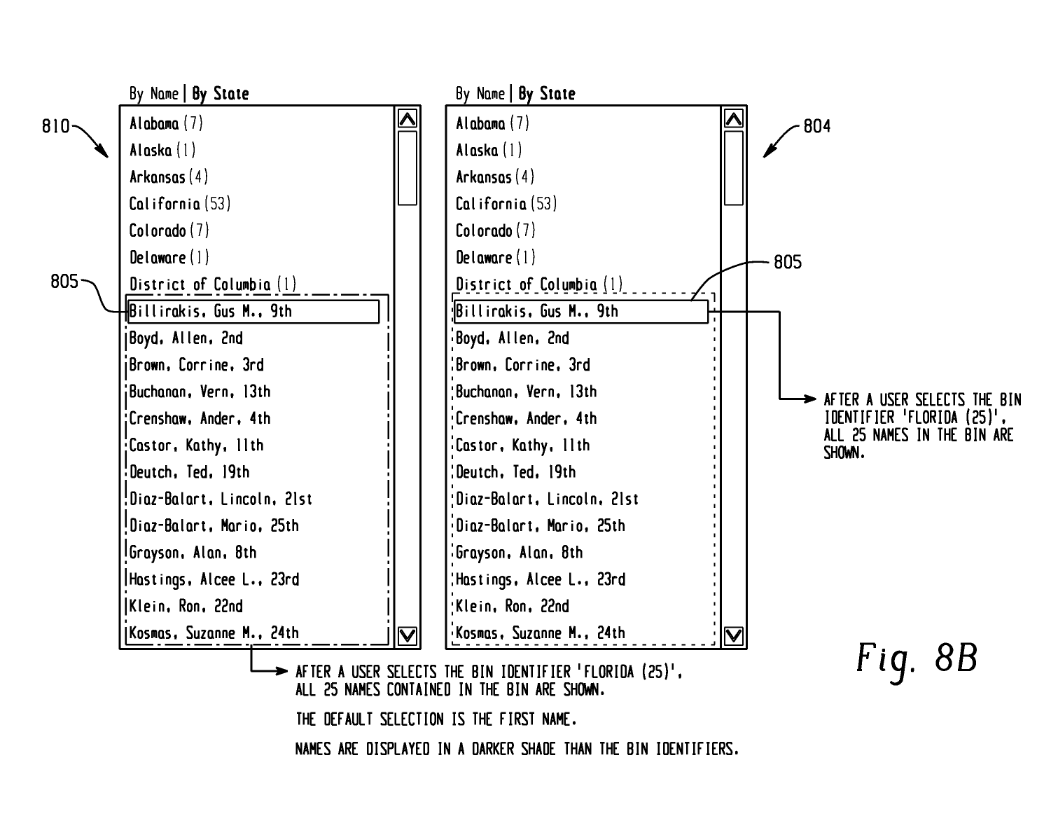

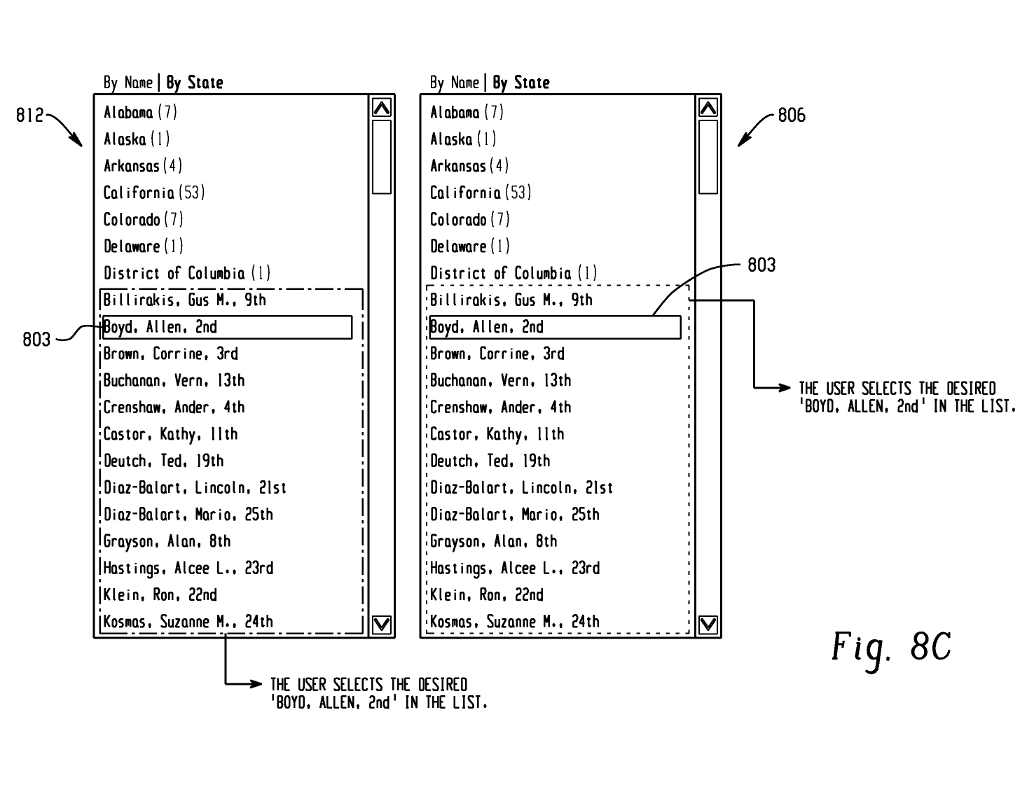

FIGS. 8A-8C depict an example embodiment where data items are assigned to bins based on states and upon user operation the list expands to get to a data item a user desires. Generally, FIGS. 8A-8C illustrate a user traversing through displayed bin identifiers (e.g., “Florida (25)” on FIG. 8A) to locate from among hundreds of names a specific name (e.g., data item “Boyd, Allen, 2nd” on FIG. 8C).

More specifically, FIG. 8A shows a one-level grouping of data items based on states. The overall list of congressmen's names are assigned into bins based on congressmen's states. A bin identifier is associated with each bin, and may include the name of a congressman's state and a number in brackets indicating how many names are in the bin. In addition, a bin identifier may comprise a bar chart to indicate the number of names contained in the bin associated with the bin identifier, as shown at 802 in FIG. 8A, 804 in FIG. 8B, and 806 in FIG. 8C. Bin identifiers are displayed in a list within a GUI.

If a user is looking for a congressman “Allen Boyd” of Florida, for example, the user can scroll to the bin identifier “Florida (25),” as shown at 802 and 808 in FIG. 8A. Then upon user operation(s) (e.g., a single click, a double-click, a mouse-over, a click-and-hold, a pinch-in or a pinch-out) on the bin identifier “Florida (25),” the list expands to display twenty five congressmen's names contained in the bin associated with the bin identifier “Florida (25),” as shown at 804 and 810 in FIG. 8B. The default selection may be the first name “Bilirakis, Gus M., 9th.” The user may move down the list to select “Boyd, Allen, 2nd,” as shown at 806 and 812 in FIG. 8C.

A color shading scheme may be used for displaying the list of congressmen's names, where a light shade is used for bin identifiers and a darker shade is used for names. For example, at 808 in FIG. 8A, the bin identifiers are displayed in a light shade, while the bin identifier “Florida (25)” is highlighted to indicate user selection. The bracketed numbers contained in the bin identifiers may take a lighter shade to indicate they are not part of the names. At 810 in FIG. 8B, the congressmen's names are displayed in a darker shade than the bin identifiers in the background.

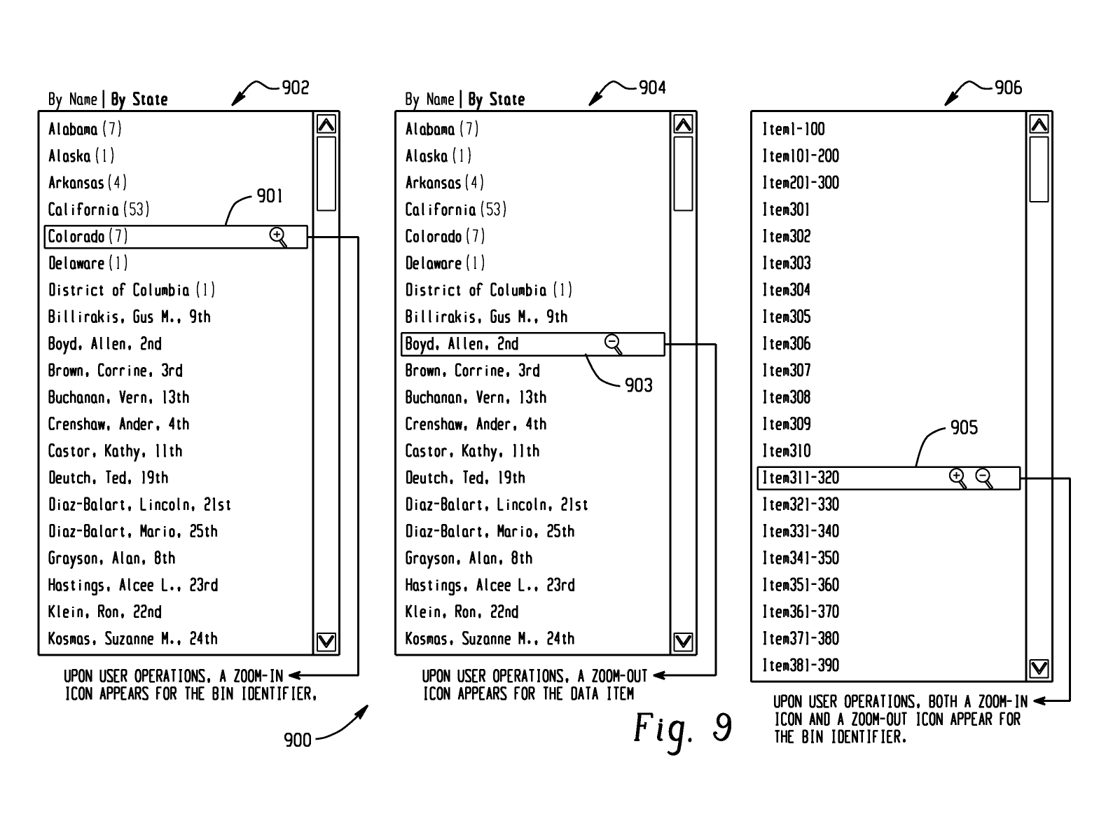

FIG. 9 depicts at 900 an example embodiment where visual indications are displayed to indicate options of expanding or collapsing a list. Visual indications (e.g., zoom-in, zoom-out icons, etc.) can be displayed in a GUI, and upon user operation on the visual indications a displayed list of data items may collapse or expand. Three example lists of bin identifiers are displayed at 902, 904 and 906. Upon user operation(s) (e.g., a single click, a double-click, a mouse-over, a click-and-hold, a pinch-in or a pinch-out), visual indications, such as zoom-in and zoom-out icons, may display to indicate options of expanding or collapsing the list. For example, visual indications may display after a user moves his mouse over a bin identifier for a while on desktop and web applications, or taps and holds a bin identifier on mobile device applications with gesture UI.

As shown at 902, a zoom-in icon displays for a bin identifier “Colorado (7)” to indicate that the list can be expanded to show content of the bin associated with the bin identifier. As shown at 904, a zoom-out icon displays for a data item “Boyd, Allen, 2nd” to indicate that the list can be collapsed to show a bin identifier associated with a bin that contains the data item. Also, as shown at 906, both a zoom-in icon and a zoom-out icon display for a bin identifier “Item 311-320,” which indicates that the list can be expanded to show content of the bin associated with the bin identifier, and the list can be collapsed to show a next higher level bin identifier. For some mobile device applications, only zoom-out icons may be needed.

This written description uses examples to disclose the invention, including the best mode, and also to enable a person skilled in the art to make and use the invention. The patentable scope of the invention may include other examples. For example, a computer-implemented system and method can be configured for a user to select an item from a list displayed in a GUI, as shown in FIG. 3, when the list of items is too long, which is often the case, users must scroll through all or a substantial portion of list items for selection. As another example, a computer-implemented system and method can be configured, as shown in FIG. 3, to alleviate the difficulty in selecting an item from a list displayed in a GUI, especially when list items cannot be displayed entirely in the screen window, a standard scrollbar must be displayed and activated by moving vertically the cursor to eventually retrieve what a user wants to select.

As an example, a computer-implemented system and method can be configured as described herein to provide a resource-saving approach, (e.g., saving user interface real estate), when displaying a large number of items in a list in a GUI. For example, the large number of items may automatically chunked into a small number of bins and displayed in a list. As another example, a computer-implemented system and method can be configured to allow users to quickly and accurately get to the vicinity of the desired data items, such as any type of application requiring data lookup and access capability. In this example, the user can scroll through a list including a small number of bins that may be expanded to a large number of items.

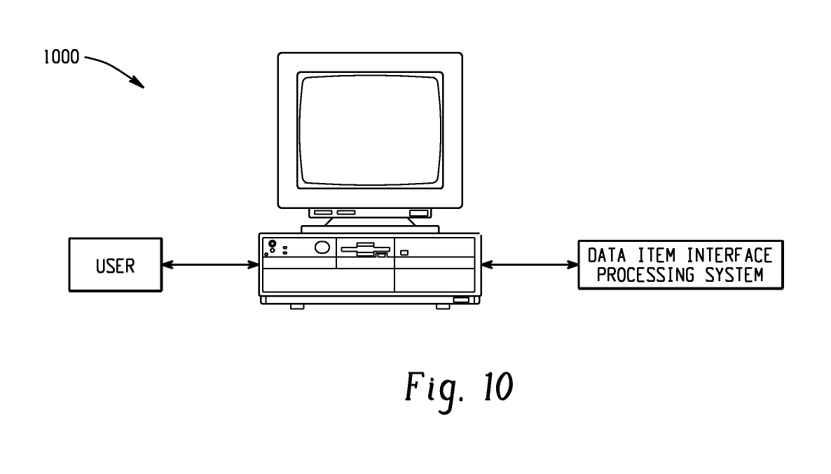

As another example, a computer-implemented system and method can be configured to allow displaying hierarchical data items. The hierarchical data items may be assigned to different levels in a hierarchy of bins based on the hierarchy of data items so that these data items may be displayed according to the levels in the hierarchy of data items. As another example, a computer-implemented system and method can be configured such that a data item interface processing system can be provided on a stand-alone computer for access by a user, such as shown at 1000 in FIG. 10.

As another example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method for displaying a number of data items within a graphical user interface, said method comprising:
receiving data items from a database;
assigning the data items, based on a first predetermined criterion, to multiple first level bins;
wherein a first level bin identifier is associated with each first level bin;
displaying one or more first level bin identifiers in a list within a graphical user interface;
upon user operation on a displayed first level bin identifier associated with a particular first level bin, displaying, in the list, data items contained in the particular first level bin;
wherein the steps of the method are performed by software instructions stored in one or more computer-readable media and executable by one or more processors.

2. The method of claim 1, further comprising:
establishing a hierarchy of bins, based on a second predetermined criterion;
wherein the first level bins occupy the lowest level of the hierarchy;
wherein each bin, other than the first level bins, contains one or more bins of a next lower level in the hierarchy;
wherein a bin identifier is associated with each bin in the hierarchy;
displaying one or more bin identifiers of a particular level of the hierarchy in the list within the graphical user interface;
upon user operation on a displayed bin identifier associated with a particular bin, displaying, in the list, data items contained in the particular bin, bin identifiers associated with bins contained in the particular bin, or data items and bin identifiers associated with bins contained in the particular bin.

3. The method of claim 2, wherein the first and second predetermined criteria are the same.

4. The method of claim 2, wherein the hierarchy of bins comprises an ordering data structure that indicates which data item belongs to which bin.

5. The method of claim 2, wherein background shades are used to indicate levels of bin identifiers displayed in the list.

6. The method of claim 2, wherein a displayed bin identifier comprises a visual indication that indicates whether bin identifiers of a different level or data items can be displayed.

7. The method of claim 2, wherein the second predetermined criterion is content of the data items.

8. The method of claim 2, wherein a displayed bin identifier that is associated with a particular bin comprises a number to indicate how many bins of a next lower level in the hierarchy or how many data items are contained in the particular bin.

9. The method of claim 2, wherein a displayed bin identifier that is associated with a particular bin comprises a label to indicate a range of bins of a next lower level or data items that are contained in the particular bin.

10. The method of claim 1, wherein the first predetermined criterion is metadata of the data items.

11. The method of claim 1, wherein a displayed first level bin identifier comprises a number to indicate how many data items are in a first level bin associated with the displayed first level bin identifier.

12. The method of claim 1, wherein a displayed first level bin identifier comprises a bar chart to indicate how many data items are in a first level bin associated with the displayed first level bin identifier.

13. The method of claim 1, wherein the user operation includes one or more of the following actions: a single click, a double-click, a mouse-over, a click-and-hold, a pinch-in or a pinch-out.

14. The method of claim 1, wherein a displayed first level bin identifier comprises a label to indicate a range of data items in a first level bin associated with the displayed first level bin identifier.

15. The method of claim 1, wherein a displayed bin identifier comprises a visual indication that indicates whether data items in a bin associated with the bin identifier can be displayed.

16. A computer-implemented system for displaying a number of data items within a graphical user interface, said system comprising:
one or more data processors;
a computer-readable storage medium encoded with instructions for commanding the one or more data processors to execute steps including:
receiving data items from a database;
assigning the data items, based on a first predetermined criterion, to multiple first level bins;
wherein a first level bin identifier is associated with each first level bin;
displaying one or more first level bin identifiers in a list within a graphical user interface;
upon user operation on a displayed first level bin identifier associated with a particular first level bin, displaying, in the list, data items contained in the particular first level bin.

17. The system of claim 16, wherein the computer-readable storage medium is encoded with instructions for commanding the data processor to execute further steps comprising:
establishing a hierarchy of bins, based on a second predetermined criterion;
wherein the first level bins occupy the lowest level of the hierarchy;
wherein each bin, other than the first level bins, contains one or more bins of a next lower level in the hierarchy;
wherein a bin identifier is associated with each bin in the hierarchy;
displaying one or more bin identifiers of a particular level of the hierarchy in the list within the graphical user interface;
upon user operation on a displayed bin identifier associated with a particular bin, displaying, in the list, data items contained in the particular bin, bin identifiers associated with bins contained in the particular bin, or data items and bin identifiers associated with bins contained in the particular bin.

18. The system of claim 17, wherein the hierarchy of bins comprises an ordering data structure that indicates which data item belongs to which bin.

19. A non-transitory computer readable medium comprising programming instructions for displaying a number of data items within a graphical user interface, the programming instructions adapted to cause a processing system to execute steps comprising:
receiving data items from a database;
assigning the data items, based on a first predetermined criterion, to multiple first level bins;
wherein a first level bin identifier is associated with each first level bin;
displaying one or more first level bin identifiers in a list within a graphical user interface;
upon user operation on a displayed first level bin identifier associated with a particular first level bin, displaying, in the list, data items contained in the particular first level bin.

20. The medium of claim 19, wherein the programming instructions are adapted to cause a processing system to execute further steps comprising:
establishing a hierarchy of bins, based on a second predetermined criterion;
wherein the first level bins occupy the lowest level of the hierarchy;
wherein each bin, other than the first level bins, contains one or more bins of a next lower level in the hierarchy;
wherein a bin identifier is associated with each bin in the hierarchy;
displaying one or more bin identifiers of a particular level of the hierarchy in the list within the graphical user interface;
upon user operation on a displayed bin identifier associated with a particular bin, displaying, in the list, data items contained in the particular bin, bin identifiers associated with bins contained in the particular bin, or data items and bin identifiers associated with bins contained in the particular bin.
